(19) United States
(12) Patent Application Publication
(10) Pub. No.: US 2013/0337711 A1
(43) Pub. Date: Dec. 19, 2013

(54) COMPOSITES HAVING LEATHER-LIKE CHARACTERISTICS

(71) Applicant: University of Delaware, Newark, DE (US)

(72) Inventor: Richard Wool, Newark, DE (US)

(73) Assignee: University of Delaware, Newark, DE (US)

(21) Appl. No.: 13/904,746

(22) Filed: May 29, 2013

Related U.S. Application Data
(60) Provisional application No. 61/652,979, filed on May 30, 2012.

(51) Int. Cl. C08K 7/02; D06N 3/00

(52) U.S. Cl. CPC C08K 7/02; D06N 3/0061
USPC 442/153; 521/149; 427/243; 264/257; 264/101

(57) ABSTRACT

This present invention is directed to the use of bio-based materials such as functionalized plant oils and natural fibers to provide substitutes for leather materials. The bio-based materials provide composites made with a range of natural fibers such as flax, cotton, jute and kenaf fibers, combined with natural plant oils (triglycerides) such as soy oil, linseed oil and their fatty acids. The natural fibers may be used in their as-delivered woven or nonwoven state and the triglycerides and fatty acids are chemically modified to allow them to react in a controlled manner giving predictable thermal and mechanical properties. The resulting material is a breathable, water resistant, leather-like material. This present invention is also directed to methods of making the substitutes for leather materials.

### CROSS-REFERENCE TO RELATED APPLICATION

This application claims priority to U.S. Provisional Application No. 61/652,979, filed May 30, 2012 and incorporated herein by reference in its entirety for all purposes.

### FIELD OF THE INVENTION

This invention pertains to the use of biobased materials such as functionalized plant oils and natural fibers to provide substitutes for leather materials. The biobased materials provide composites made with a range of natural fibers such as flax, cotton, jute and kenaf fibers, combined with natural plant oils (triglycerides) such as soy oil, linseed oil and their fatty acids. The natural fibers may be used in their as-delivered woven or nonwoven state and the triglycerides and fatty acids are chemically modified to allow them to react in a controlled manner giving predictable thermal and mechanical properties. The resulting material is a breathable, water resistant, leather-like material.

### BACKGROUND OF THE RELATED ART

The objective of this invention is to replace leather-like materials with more engineered composite materials derived from renewable resources in a manner to make them better, cheaper and with less impact on the environment. Leather is the most profitable byproduct of the meat and dairy production industries; currently, producing 20 billion square feet of leather products annually. The five main industries that use large amounts of leather are furniture (14% upholstery), automobile (10%), clothing (14%), and footwear (52%). The countries that produce the most leather are China, Italy, India, Brazil and Korea. The United States is the 10^{th} largest producer in the World, however a significant portion of this industry has been moved to foreign countries with more relaxed environmental restrictions. In 1985, the EPA placed restrictions on the waste water treatment levels in the US tanning industry. Additionally, the Clean Air Act imposed limitations on the level of volatile organic compound (VOC) emissions for all industries in 1990. These measures significantly cleaned up the United States tanning industry, reducing chromium levels and water usage by 50% in less than 15 years. However, these measures also increased the cost of producing tanned leather in the United States. By 2000, the US was exporting more raw hides to foreign countries to be tanned because it was less expensive to export the hide and import the finished goods than it was to tan the hide. The tanning industry wastes 15,000 gallons of water and creates 2,200 pounds of solid waste for every ton of leather produced. This amounts to 150 billion gallons of water wasted and 22 billion pounds solid waste created annually. In the conventional tanning processes, relatively safe chromium III turns into the hazardous chromium VI. Depending on the level of exposure, some human health problems caused by chromium VI exposure include respiratory problems, weakening of the immune system, kidney and or liver damage, genetic material alteration, lung cancer, and or possible death. When dissolved in water, chromium VI forms chromic acid, which when ingested can cause organ corrosion for both humans and animals. Other effects on animals include negative effects on respiratory and reproductive processes. Effects on plants include photosynthesis inhibition as well as stunting of plant growth and development. Both plants and animals suffer from chromium VI toxicity at low concentrations of chromium VI. This is an important green engineering problem.

Many alternatives to leather have been developed over the last half-century but their environmental impact of production compared to that of leather has been a topic of hot debate. Plasticized faux leather falls into two categories: imitation leather and synthetic leather. As early as the 1950's, imitation leather was being manufactured using leather-grain embossed poly-vinyl-chloride (PVC) or polyurethane (PU) materials on cloth. This process, still in use today, involves applying a melted plastic syrup onto a leather-grain embossed “release paper”, baking it at high temperatures, coating with a second plastic foam layer, and then removing the material from the paper and coating it underneath with fabric. Naugahyde® is the best known of the imitation leathers and is still used today in making seat cushions and furniture.

Imitation leather very often has the look of natural leather but rarely attains the breathability and texture of natural leather. Therefore, its use is limited to seat cushions and furniture, most commonly seen in booths at restaurants. One benefit of using the material however, is its wide variability in appearance as it can be embossed with virtually any type of leather grain, taking on the appearance of crocodile, snake, and other exotic leather looks.

Additionally, the material costs less, selling for $0.009/in² while natural leather sells anywhere between $0.01/in² and $0.15/in², depending on its quality. The quality of imitation leather can vary, sometimes suffering from color fading or tearing. Naugahyde's NaugaLeather® however, has many quality features including a “leather look and feel”, construction from “strong and durable” material, ability to be “clean(ed) easily with mild soap and water”, using “U.V. stabilized pigments” for dyeing, and “meet(ing) GSA upholstery requirements for tear strength, stitch tear resistance, and tensile strength”. In general, imitation leather competes well with natural leather for upholstery applications based on price and quality.

Synthetic leather is essentially made up of polyamide (PA) or nylon microfibers obtained by a slightly more involved process that seeks to emulate the collagen structure of natural leather. Starting in 1963 with DuPont's introduction of Corfam®, synthetic leather became a booming industry by the 1970's and 80's. The special treatment that gives synthetic leather its properties includes needle punching, web shrinkage, and selective dissolution of impregnated fibers. Needle punching involves penetrating a cross-linked polymer substrate with barbed needles in order to tangle and vary the density of the fibers, thereby strengthening the overall material. Web shrinkage is accomplished by taking the substrate through increasing temperature baths, thereby shrinking a mass of fibers into a tightly packed bundle. Lastly, when coated with a hygroscopic coating, the material absorbs water that coagulates the polymer, leaving behind pores reminiscent of leather. The material can then be buffed, napped and dyed to make suede-type synthetic leather or coated with polyurethanes to make grain-type. Corfam® has since been replaced by other products, such as Ultrasuede®—a suede-type synthetic and Clarino®—a grain-type synthetic, which both have a wide variety of applications and compete very well with natural suede and leather.

Synthetic leather is not only able to rival the appearance of natural suede and leather but can also match the feel, durability, and breathability of natural leather. The porosity and imperfections achieved during its processing give synthetic leathers a breathability and comfort that allow it to be used in sports equipment, gloves, footwear, upholstery, and even the highly critical fashion industry. Although slightly more expensive than imitation leather, synthetic leather is still very reasonably priced for its quality. Ultrasuede is sold for $0.025/in², while natural suede starts out at $0.007/in² and can go up depending on its quality. Even the highest quality suede is matched by Kururay's Clarino, which claims that its various configurations meet all requirements for “weight, flexibility, durability, and quality” and “surpass natural leather's special, inherent qualities”. Overall, synthetic leathers are an all-around market rival for natural leather in quality, durability, and price.

While resembling leather by either appearance or structure, it is important that faux leathers emulate the tensile properties of real leather and have a similar flexibility. To observe the tensile properties of faux leather, one can look to available data for the materials that make it up, namely PVC, PU, and PA compared to leather. Natural leather has variable properties depending on its quality and the way in which it is treated but generally has a Young's modulus ranging 0.0145-0.0725 10⁶ psi and yield strength of 0.290-0.725 ksi. PAs have a Young's modulus near 0.38-0.464 10⁶ psi and yield strengths that range from 7.25-13.7 ksi, PVCs have a Young's modulus of 0.31-60 10⁶ psi and yield strengths ranging from 5.13-7.56 ksi, and PUs have a Young's modulus of 0.0029-0.00425 10⁶ psi and yield strengths of 3.63-7.4 ksi. With the exception of the Young's modulus of PU, these plastics exceed the mechanical properties of leather and are manufactured such that they have similar flexibility without compromising durability.

For a thorough analysis: the energy input and environmental impact of producing artificial leather compared to that of real leather must be examined. Real leather has an embodied production and processing energy of 11,152-12,257 kcal/lb, a CO₂ footprint of 4.118-4.542 lb CO₂/lb leather produced, and an immense water usage of 480.52-502.16 gal/lb. All plastic faux leathers have comparable energy and CO₂ impacts. However they avoid the use of toxic and persistent Chromium salts and use much less water in their manufacture. PVC has less energy inputs than leather with production and processing energy ranges 8,995-12,085 kcal/lb, total CO₂ footprint of 3.397-3.920 lb CO₂/lb PVC produced, water usage of 2.26-6.79 gal/lb, yet its thermal degradation can release toxic compounds such as dioxins into the atmosphere. Polyurethane has slightly higher values of production with an energy input of 12,571-13,893 kcal/lb, CO₂ footprint of 5.040-5.599 lb CO/Ib polyurethane produced, water usage of 20.1-60.2 gal/lb, and can be problematic in the long term as it cannot be recycled, creating disposal issues. Polyamides present the most promising alternative, having higher production inputs with embodied energy of 14,714-16,377 kcal/lb, CO footprints of 6.693-6.914 lb CO₂/lb of polyamide produced, water usage of 16.3-48.9 gal/lb, but exhibiting very little toxic environmental effects. As PA leather use in synthetic leather is the primary competitor for leather products, replacing a leather product with a synthetic one could significantly benefit the environment. Additionally, incorporation of a renewable soy-based plastic with natural fibers into manufacturing could make faux leather production a much greener technology.

### SUMMARY OF THE INVENTION

One aspect of the invention provides a composite having leather characteristics (sometimes referred to herein as “eco-leather”), comprising a natural fiber and a cured resin matrix obtained from a curable resin comprised of at least one bio-based component selected from the group consisting of functionalized triglycerides, functionalized fatty acids, functionalized fatty acid monoesters and functionalized fatty acid diesters, wherein the composite contains microvoids which render the composite permeable and breathable.

Another aspect of the invention provides a curable resin comprised of at least one functionalized triglyceride, at least one functionalized fatty acid (such as at least one (meth)acrylated fatty acid) or at least one functionalized monomer (such as vinyl aromatic monomers and/or (meth)acrylate monomers). Another aspect of the invention provides a natural fiber in the form of a fabric, such as a woven or non-woven fabric, wherein the natural fiber is selected from the group consisting of flax fibers, hemp fibers, jute fibers, kenaf fibers, coir fibers, ramie fibers, sisal fibers, cotton fibers, cellulose fibers, bamboo fibers and mixtures thereof.

Yet another aspect of the invention provides a curable resin that includes at least one of maleinized (meth)acrylated epoxidized triglyceride, (meth)acrylated epoxidized triglyceride, (meth)acrylated fatty acid and a vinyl aromatic monomer. Yet another aspect of the invention provides composites having a modulus of elasticity of between about 0.08 GPa to about 2.0 GPa and/or a tensile strength of about 32 MPa to about 70 MPa. Yet another aspect of the invention provides composites having porosities between about 0.001% to about 5% and preferably, between about 1% to about 3%, pore sizes between about 5 nm to about 100 μm and/or viscosities between about 10-10,000 centipoise (cP) and preferably, between about 100-500 cP.

Still another aspect of the invention provides a method of making a composite having leather characteristics, the method comprising impregnating a natural fiber with a curable resin comprised of at least one bio-based component selected from the group consisting of functionalized triglycerides, functionalized fatty acids, functionalized fatty acid monoesters and functionalized fatty acid diesters to obtain an impregnated natural fiber containing microvoids and curing the curable resin to obtain a cured resin matrix containing the natural fiber, wherein the composite is permeable and breathable.

Still another aspect of the invention provides the impregnating step as comprising spreading the curable resin on the natural fiber and hot pressing the curable resin and the natural fiber in a mold. Still another aspect of the invention provides degassing the resin in a vacuum. Still another aspect provides a method that is a liquid infusion method selected from the group consisting of resin transfer molding, vacuum assisted resin transfer molding, sheet compound molding and bulk compound molding.

### DETAILED DESCRIPTION OF THE INVENTION

The present invention will now be described in detail with reference to a few preferred embodiments thereof. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Wetting tests of the resins with various fibers showed that some were compatible and some incompatible. In subsequent experiments, the compatible resin/fiber composites gave the best leather-like properties. Most surprisingly, these experiments clearly show that the liquid molding process resulted in composites that were breathable. This occurs by a process where compatible natural fibers soak up the resin leaving micro voids behind in the cured composite matrix which allow gas to permeate while preventing moisture uptake, similar to Gore-Tex® fabric. This is the most difficult aspect of leather to replicate and enhances their potential as a leather substitute. By selecting the chemical formulation of the resin and the fatty acid distribution function, it was possible to make a range of leather-like materials with varying thermal and mechanical properties suited to soft, medium or hard leather applications. The new materials can be fabricated to provide a very close match to the physical properties of leather. Liquid molding manufacturing operations such as Resin Transfer Molding (RTM), Vacuum Assisted Resin Transfer Molding (VARTM), Sheet Molding Compound (SMC), Bulk Molding Compound (BMC) and related liquid infusion processes can be used to mass produce new leather-like materials with excellent properties. The new leather-like materials are very environmentally friendly: (a) they have near 100% biobased content derived from atmospheric CO₂ via photosynthesis; (b) they are non-toxic since both the fibers and the plant-oil based resins are biocompatible (the low toxicity of the new materials is in stark contrast to the toxicity of the highly polluting leather tanning industry); (c) the embodied energy is very low compared to petroleum substitutes and (d) the overall low carbon footprint will help eliminate global warming. The new eco-friendly composites of the present invention can be readily utilized in the main industries that use large amounts of leather, namely, furniture (upholstery), automobile, clothing, and footwear. The annual leather market of 20 billion sq² represents a potential billion dollar business in new leather substitute materials.

Triglycerides are the main component of plant oils, such as soybean oil, corn oil, etc. Triglycerides are composed of three fatty acids connected by a glycerol center. Most triglycerides contain at least some level of unsaturated fatty acid moieties, including mono- and polyunsaturated fatty acid moieties such as oleic acid, linoleic acid and the like. There are numerous ways of chemically modifying the unsaturation sites on the fatty acids, many of which can be used to make polymers. For example, the unsaturation sites may be epoxidized; epoxidized and (meth)acrylated; (meth)acrylated; hydroxylated and maleinized; epoxidized, (meth)acrylated and maleinized; or maleinized and (meth)acrylated. The functional groups introduced thus may be, for example, epoxy groups, (meth)acrylate groups, maleinate groups, and the like. Saturated fatty acids may also be functionalized, such as by (meth)acrylatioi of the carboxylic acid group. Methods for introducing functional groups into triglycerides, fatty acids, fatty acid monoesters and fatty acid diesters are well known in the art and are described, for example, in the following United States published patent applications and granted patents, each of which is incorporated herein by reference in its entirety for all purposes: US 2002/0188056; US 2003/0088007; US 2004/0072976; and U.S. Pat. No. 6,121,398.

The chemically modified (functionalized) triglycerides, fatty acids, fatty acid monoesters and fatty acid diesters used in the present invention have multiple functional sites per molecule, which allow the resins to cross-link. In addition, VE, UPE and TGD resins are typically copolymerized with a low molecular weight species, such as styrene, to modify the properties of the polymer. The low viscosities of these resins make them ideal for inexpensive polymer composite fabrication processes, such as vacuum assisted resin transfer molding.

Triglyceride-based resins are an attractive alternative to petroleum-based resins because they are inexpensive, have good properties, and are derived from renewable resources. Furthermore, the advent of genetic engineering technology, which can drastically change the fatty acid composition of triglycerides in plant oils, offers a large potential for inexpensively improving the properties of these polymers. Typically triglyceride-based polymers form gels, which can be hard or soft depending on the level of functionalization of the triglycerides, extent of polymerization, co-monomer type, and co-monomer content.

In this invention, functionalized triglycerides, fatty acids, fatty acid monoesters and fatty acid diesters are used to achieve the desired leather properties, e.g. stiffness, durability, breathability, strength, moisture resistance, thermal resistance, touch and aesthetics. The mixtures of oils may be selected and functionalized in accord with the chemical schemes shown below. Examples of suitable functionalized oils, chemical structure and their nomenclature are summarized in the following Table 1. The oils may be used in their triglyceride structure or in their individual fatty acids or monoesters or diesters of such fatty acids, typically in the form of methyl esters (which may be obtained by heating a triglyceride in the presence of methanol and alkali). Suitable triglycerides useful as starting materials to prepare reactants suitable for use in the present invention include, for example, oils obtained from natural sources (plants, animals), in particular triglycerides containing unsaturated fatty acid moieties (oleic, linoleic, linolenic, etc.). The triglycerides may, of course, also contain saturated fatty acid moieties. Exemplary triglycerides include, but are not limited to, soy oil, corn oil, cottonseed oil, peanut oil, canola (rapeseed) oil, olive oil, linseed oil, sunflower seed oil, castor oil and the like.

The functionalized triglycerides, fatty acids, fatty acid monoesters and fatty acid diesters may be utilized in combination with one or more other types of functionalized monomers. Suitable functionalized monomers include, for example, polymerizable monovinyl and polyvinyl compounds such as (meth)acrylic acid, (meth)acrylates (e.g., methyl methacrylate), aromatic vinyl monomers (e.g., styrene), and the like.

TABLE 1
Illustrative Natural Oils and their Reactions

| Natural Oil or Modified Oil | Reaction | Name-Acronym |
|---|---|---|
| Soy Oil | Epoxidation | ESO |
| ESO | Acrylation | AESO |
| AESO | Maleinization | MAESO (1, 2, 3) |
| Linseed Oil | Acrylation | AELO |
| AELO | Maleinization | MAELO (1, 2, 3) |
| High Oleic Soy Oil | | HOSO |
| Oleic Methyl Ester Fatty Acid | | OME |
| OME | Acrylation | AFAME |
| Lauric Fatty Acid | Methacrylation | MLA |

### Illustrative Functionalized Fatty Acids:

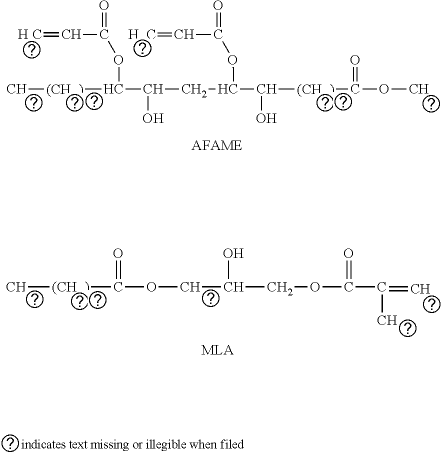

The oils and fatty acids are selected and chemically functionalized to achieve the mechanical and thermal properties required to perform as eco-leather materials as follows. The modulus E is determined from dynamic mechanical analysis above the glass transition temperature Tg and is a measure of the effective cross-link density of polymers. The cross-link density of a polymer can be determined from the theory of rubber elasticity by the following equation:

E−3vRTE=3υRT (Eq. 1)

where v is the cross-link density, E is the elastic modulus of the polymer in the plateau region above Tg. In this invention, Tg+40 (K) was used in the calculation. R is the ideal gas constant (8.314 J K⁻¹ mol⁻¹), and T is the absolute temperature (K).

The number of cross-links in the network of n components can be expressed as a function of the composition of the oils and fatty acid distribution and the functionality of the triglycerides by

$$u = \text{?} v = {\sum }_{i = 1}^{n} \frac{ρ {w}_{i} ( 3 {f}_{i} {X}_{i} - 3 )}{M {W}_{i}} \\ \text{?} \text{indicates text missing or illegible when filed} \qquad ( Eq . 2 )$$

where ρ is the density of the polymer, w is the weigh fraction of the multifunctional components in the resins, f is the number of polymerizable groups (e.g. C═C double bond in this study) in the monomer molecule, X is the extent of polymerization, MW is the monomer molecular weight of each monomer, and subscript i denotes ith component.

For example, the functionalized oil AESO contains about 3.4 Acrylates per triglyceride. Typically, the extent of reaction X is 0.99 for acrylate groups. The molecular weight of AESO is 1186 g/mol. The density of the polymers is around 1080 kg/m³. These numbers were used as f in Eq. 1 to calculate the cross-link density of the polymer.

It is well known that introducing cross-links into a polymer raises the glass transition temperature (Tg). The present inventor developed the Twinkling Fractal Theory (TFT) to relate the crosslink density to Tg as:

$${T}_{g} ( v ) = {T}_{g}^{0} + \frac{{T}_{g}^{0} {M}_{ax}}{ρ ( 1 - {p}_{c} )} v \qquad ( Eq . 3 )$$

where ρ is the density of the material, Mₒₓ is the molecular weight per backbone atom of the cross-link chain structure, ρ_{c}≈0.5 is the vector percolation threshold and T_{g}⁰ is the T_{g} of the linear polymer extrapolated to v=0. According to the Twinkling Fractal Theory of Tg, the Tg is linearly dependent on the cross-link density v.

The Fox equation was employed to predict T_{g} values for this multi-component polymer mixture, taking into account the respective values for each component of the system.

$$\frac{1}{{T}_{g , system}} = {( \frac{{w}_{1}}{{T}_{g , 1}} + \frac{{w}_{2}}{{T}_{g , 2}} + … + \frac{{w}_{n}}{{T}_{g , n}} )}_{\frac{1}{{T}_{g , sys}} = ( \frac{{w}_{1}}{{T}_{g , 1}} + \frac{{w}_{2}}{{T}_{g , 2}} + … + \frac{{w}_{n}}{{T}_{g , n}} )}$$

where T_{g}, system is the glass transition of the polymeric matrix, T_{g, i} is the glass transition of component i in the system and wᵢ is the weight fraction of component i in the matrix. The values of T_{g} (determined as tan delta peak) employed in this work are: −27° C. for MLA, 58° C. for AESO, 80° C. for MAESO, 117° C. for SOMG/MA and 124° C. for COMG/MA. This model was used to predict the T_{g} for all polymeric bio-based systems used in the development of the eco-leather of the present invention.

The resulting polymers range from soft rubbers to rigid thermosets with varied applications such as elastomers, composites, adhesives and foams and when combined in a special manner with natural fibers, one obtains an eco-leather with the desirable range of properties.

Important factors in the development of the eco-leather composites of the present invention are as follows.

The natural fibers must be compatible with the selected resin matrix. Compatibility is determined by the ability of the liquid resin to wet and spread readily on the fibers. Non wetting resins will not produce breathable composites necessary for eco-leather. Use of compatibilizers on the fibers will enhance the bonding of the resin to the fibers with improved composite properties but will not provide breathability. Examples of compatible natural fibers are flax, hemp, jute, kenaf, coir, ramie, sisal, cotton, cellulose, bamboo, etc., and can have many different weaves well known to the textile industry. The fibers may be in the form of a fabric, wherein the fabric is woven or non-woven. The composite may contain a single layer of fabric or a plurality of fabric layers (with the fabric layers being the same as or different from each other). The type of fabric weave (0/90, +45/−45, single strand, etc.) can impact on the mechanical properties of individual laminates in the composite and these are well known to the composite and textile community. The overall properties of the composite are determined by the selection of different natural fiber laminates and this selection is essentially infinite and attests to the broad design flexibility of this invention.

The fiber-resin compatibility coupled with the voids and defects in the natural fibers allows the fiber to suck-in or imbibe the resin in the mold, typically leaving a small void or microcavity in the matrix, which is the source of the permeability and breathability of the eco leather composites. This microvoiding process is the surprising event which underscores the importance of this invention. It does not happen with normal glass, carbon or aramid fibers and will not happen with natural fibers unless the physical conditions are correct and these are primarily (a) chemical compatibility, (b) low viscosity of resin and (c) voids within the natural fiber with external surface access to the voids. This allows the fibers to “sponge up” the resin leaving voids behind and displaced air from the fibers, which combine to enhance the permeability of the composite. This permeability can be controlled for individual fabric weaves and composite laminate configuration. In addition to eco-leather like applications, the resulting composites can be used in many other applications where permeability is important such as, gas and liquid filtration, adsorption, membranes etc.

When the microvoids have formed, the composite can then be cured in the traditional manner using catalysts, initiators and temperature control. For example, a peroxide or other type of free radical initiator may be utilized as a catalyst. The resin-impregnated fiber may be heated to effect curing (crosslinking) of the reactive components of the resin within an acceptably short period of time. The composites are found to have favorable properties, such as porosity, pore size and viscosity. For example, porosities of the composites typically range from about 0.001% to about 5% and preferably, the porosities of the composites are between about 1% to about 3%. The pore sizes are not particularly limited and may be from about 5 nm to about 100 μm. The viscosities of the composites typically range from about 10-10,000 centipoise (cP) and preferably, the viscosities of the compositions are between about 100-500 cP.

### Composite Manufacturing Method

The natural fiber fabrics were cut into the size of the mold (8′×8″) in a single layer ply. All the natural fiber fabrics used were available commercially. The resin mixture was degassed in a vacuum oven for 10 min to remove bubbles before being cured. The resin was then spread on the fibers in the mold which was subsequently closed. The mold was then compressed using a hot press with various pressures. Composites were cured with 1.5 wt % initiator at 90° C. for 2 hr and then post-cured at 120° C. for 2 hr. Table 2 lists the particular materials tested and their measured properties.

For comparison purposes, Table 3 lists the typical mechanical properties of leather as determined by C-K Liu at the USDA laboratories in Philadelphia, Pa. (as reported in JALCA, Vol. 102, 2007). The leather tested had been obtained from bovine hides, tanned with chrome and had a thickness of 1.2 mm. The milling is a mechanical method of treating the leather to break up fiber clusters and give a softer texture. Tensile strengths of the order of 16 MPa and Modulus of 16-30 MPa can be considered representative if not target properties for many leather applications. These results are consistent with those reported in various media. For example, a leather belt is reported to have a tensile strength of 20-30 MPa. Such materials could be used in several components of the leather shoe structure, including uppers, heels and soles.

TABLE 2
Eco-Leather Composites and Natural
Fiber Mechanical Property Results

| | | | Modulus of | Tensile | Strain |
|---|---|---|---|---|---|
| | Material | Wt % | Elasticity | Strength | % at |
| Fiber Type | Tested | Fiber | (GPa) | (MPa) | Break |
| Natural | Fiber alone | 100 | 0.213 | 16.25 | 30.97 |
| Linen | Fiber + | 47 | 0.089 | 12.76 | 14.02 |
| | AESO/MLAU | | | | |
| | (50/50) | | | | |
| Brown | Fiber alone | 100 | 0.949 | 40.01 | 16.82 |
| Flax | Fiber + | 54 | 1.742 | 65.46 | 3.7 |
| | AESO/MLAU | | | | |
| | (50/50) | | | | |
| | Fiber + | 51 | 1.444 | 57.33 | 5.1 |
| | AESO/MLAU | | | | |
| | (70/30) | | | | |
| | Fiber + CB4 | 48 | 1.846 | 70.36 | 3.81 |
| White | Fiber alone | 100 | 0.473 | 14.14 | 10.93 |
| Linen | Fiber + | 51 | 1.666 | 55.14 | 3.3 |
| | AESO/MLAU | | | | |
| | (50/50) | | | | |
| | Fiber + | 46 | 1.362 | 45.09 | 3.28 |
| | AESO/MLAU | | | | |
| | (50/50) | | | | |
| Coarse | Fiber alone | 100 | 1.104 | 39.86 | 11.71 |
| Linen | Fiber + CB4 | 43 | 0.628 | 46.31 | 7.13 |
| Heavy | Fiber alone | 100 | 0.63 | 21.01 | 10.09 |
| Burlap | Fiber + | 53 | 0.617 | 44.44 | 7.24 |
| | AESO/MLAU | | | | |
| | (50/50) | | | | |
| | Fiber + CB4 | 43 | 0.665 | 35.05 | 5.42 |

TABLE 3
Mechanical Property Data for Non-
milled and Milled Leather Samples

| | Tensile | Elongation | Young's | Toughness |
|---|---|---|---|---|
| Sample | Strength (MPa) | (%) | Modulus (MPa) | (J/cm³) |
| Non- | 14.4 ± 0.94 | 34.0 ± 0.65 | 29.8 ± 3.5 | 2.38 ± 0.24 |
| milled | | | | |
| Milled | 16.3 ± 1.6 | 37.6 ± 1.7 | 16.9 ± 1.9 | 2.70 ± 0.26 |

### EXAMPLES

### Example 1

### Material: AESO/MLAU (50/50)+47 wt % Washed Linen Fiber

This example utilized a resin which is composed of 50% AESO (acrylated epoxidized soy oil) and 50% MLAU, which is a functionalized softening fatty acid (methacrylated lauric acid). The composite was made with 53 wt % of this resin combined with 47 wt % of the washed linen fibers. These fibers exhibited good wetting properties with this resin. The fibers by themselves have a modulus of elasticity E=0.2 GPa, which can be considered low for natural fibers, but their tensile strength σ=16 MPa is consistent with leather properties. The composite properties are considered to be good and suited to use as a soft leather: The modulus of elasticity is E=0.089 GPa or 89 MPa. The tensile strength of 12.7 MPa is also within the target leather range. The strain at break is quite respectable also.

### Example 2

### Material: AESO/MLAU (50-50)+54 wt % Brown Flax Fiber

The fiber by itself is stiff with E=1 GPa and tensile strength of 40 MPa, which is better than most leathers. The fiber is very compatible with the resin and this impacts positively on the composite properties. The composite properties are excellent with 54 wt % fiber giving a modulus of 1.7 GPa, which is quite stiff, and the tensile strength is 65 MPa. Note that despite the addition of a softer resin, both of the composite properties exceed that of the bare fibers, which is most unusual but can be understood in terms of the compatibility of the resin with the fibers. The resin is soaked up by the fibers and improves the fibers basic properties.

Composition: 54 wt % fiber; 1 layer

Properties: very flexible, semipermeable, water repellant.

### Example 3

### Material: AESO/MLAU (70-30)+51 wt % Brown Flax Fiber

This composite has a higher AESO content compared to the material of Example 2, but the properties are comparable to a stiff leather material.

Properties: flexible, semipermeable, water repellant.

Composition: 1 layer, 51 wt % fiber.

### Example 4

### Material: CB4+48 wt % Brown Flax Fiber

The resin used, CB4, contains 70% by weight of maleinized acrylated epoxidized soy oil (MAESO) and 30% by weight of styrene monomer. This composite is quite stiff with a modulus of 1.8 GPa and has a very high tensile strength of 70 MPa which exceeds that of typical leather materials

### Example 5

### Material: AESO/MLAU (50-50)+51 wt % White Linen Fiber

This fiber has a stiffness of 0.47 GPa and a tensile strength of 14 MPa, comparable to leather. When combined with the resin, the composite exhibits stiffer properties than the fiber and an excellent tensile strength of 55 MPa. Composition: 51 wt % fiber.

Properties: Very flexible, thin, partially compatible.

### Example 6

### Material: AESO/MLAU (70-30)+46 wt % White Linen Fiber

This material is softer than the composite of Example 5, but with comparable properties.

Composition: 1 layer, 46 wt % fiber.

Properties: very flexible, water repellant, semi permeable.

### Example 7

### Material: CB4+43 wt % Coarse Linen Fiber

This fiber was compatible with the CB4 resin. The composite shows good stiffness of 0.6 GPa and strength of 46 MPa and good strain at break at 7%. Composition: 43 wt % fiber; 1 layer.

Properties: Flexible, non-wettable, semi-permeable.

### Example 8

### Material: AESO/MLAU (50-50)+53 wt % Burlap Fiber

This fiber is highly compatible with the resin, which may help to explain why the composite strength exceeds that of the bare fibers. The stiffness is 0.6 GPa and the strength is 44 MPa. The strain at break of 10% also suggests good toughness.

### Example 9

### Material: CB4+43 wt % Coarse Burlap Fiber

This composite has a stiffness of 0.6 GPa and a strength of 34 MPa.

Composition: 43 wt % fiber; 1 layer.

Appearance: Brown.

Properties: Medium stiffness Water repellant, gas permeable.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A composite having leather characteristics, comprising a natural fiber and a cured resin matrix obtained from a curable resin comprised of at least one bio-based component selected from the group consisting of functionalized triglycerides, functionalized fatty acids, functionalized fatty acid monoesters and functionalized fatty acid diesters, wherein the composite contains microvoids which render the composite permeable and breathable.

2. The composite of claim 1, wherein the curable resin is comprised of at least one functionalized triglyceride and at least one functionalized fatty acid.

3. The composite of claim 2, wherein the curable resin includes at least one (meth)acrylated fatty acid.

4. The composite of claim 1, wherein the curable resin is additionally comprised of at least one functionalized monomer.

5. The composite of claim 4, wherein at least one functionalized monomer is selected from the group consisting of vinyl aromatic monomers and (meth)acrylate monomers.

6. The composite of claim 1, wherein the natural fiber is in the form of a fabric.

7. The composite of claim 1, wherein the natural fiber is in the form of a woven fabric.

8. The composite of claim 1, wherein the natural fiber is selected from the group consisting of flax fibers, hemp fibers, jute fibers, kenaf fibers, coir fibers, ramie fibers, sisal fibers, cotton fibers, cellulose fibers, bamboo fibers and mixtures thereof.

9. The composite of claim 1, wherein the curable resin includes at least one maleinized (meth)acrylated epoxidized triglyceride and/or at least one (meth)acrylated epoxidized triglyceride.

10. The composite of claim 1, wherein the curable resin includes at least one (meth)acrylated fatty acid.

11. The composite of claim 1, wherein the curable resin includes at least one (meth)acrylated epoxidized triglyceride and at least one (meth)acrylated fatty acid.

12. The composite of claim 1, wherein the curable resin includes at least one maleinized (meth)acrylated epoxidized triglyceride and at least one vinyl aromatic monomer.

13. The composite of claim 1, wherein the bio-based component contains one or more functional groups per molecule selected from the group consisting of (meth)acrylate groups and maleinate groups.

14. The composite of claim 1, wherein the composite has a modulus of elasticity of between about 0.08 GPa to about 2.0 GPa and/or a tensile strength of about 12 MPa to about 70 MPa.

15. The composite of claim 1, wherein the composite has a porosity between about 0.001% to about 5% and/or a viscosity between about 10-10,000 cP.

16. A method of making a composite having leather characteristics, the method comprising impregnating a natural fiber with a curable resin comprised of at least one bio-based component selected from the group consisting of functionalized triglycerides, functionalized fatty acids, functionalized fatty acid monoesters and functionalized fatty acid diesters to obtain an impregnated natural fiber containing microvoids and curing the curable resin to obtain a cured resin matrix containing the natural fiber, wherein the composite is permeable and breathable.

17. The method of claim 16, wherein the impregnating comprises spreading the curable resin on the natural fiber and hot pressing the curable resin and the natural fiber in a mold.

18. The method of claim 16, further comprising degassing the resin in a vacuum.

19. The method of claim 16, wherein the method is a liquid infusion method selected from the group consisting of resin transfer molding, vacuum assisted resin transfer molding, sheet compound molding and bulk compound molding.

20. A composite made by the method of claim 16.
